(19) United States
(12) Patent Application Publication
(10) Pub. No.: US 2019/0387219 A1
(43) Pub. Date: Dec. 19, 2019

(54) DISPLAY SYSTEM, DISPLAY METHOD, AND REMOTE OPERATION SYSTEM

(71) Applicants: Komatsu Ltd., Tokyo (JP); Osaka University, Suita-shi (JP)

(72) Inventors: Daisuke Kondo, Osaka (JP); Takanobu Tanimoto, Osaka (JP); Yu Nanri, Osaka (JP); Hiroshi Yoshinada, Tokyo (JP)

(21) Appl. No.: 16/484,250

(22) PCT Filed: Dec. 28, 2017
(86) PCT No.: PCT/JP2017/047205

§ 371 Date: Aug. 7, 2019

(30) Foreign Application Priority Data
Mar. 13, 2017 (JP) 2017-047904

(51) Int. Cl. H04N 13/366; H04N 5/225; H04N 7/18; G05D 1/00

(52) U.S. Cl. CPC H04N 13/366; H04N 5/2253; G05D 1/0016; G05D 1/0038; H04N 7/183

(57) ABSTRACT

A display system includes an image-data acquisition unit that acquires image data including three-dimensional data of an object at a work site, a viewpoint-position-data acquisition unit that acquires viewpoint position data of a worker, and a display control unit that displays a free-viewpoint image of the object based on the image data and the viewpoint position data.

### FIELD

The present invention relates to a display system, a display method, and a remote operation system.

### BACKGROUND

As a method for automating work machines, a method of remotely operating work machines has been proposed. When a work machine is remotely operated, an image of a work site is transmitted to a display apparatus at a remote place. A worker remotely operates the work machine while viewing the image of the work site displayed on the display apparatus. Patent Literature 1 discloses a tele-operating system including a TV camera that photographs a work site, a head-position detection sensor that detects the position of the head of a worker, an actuator that controls the direction of the TV camera so that the photographing direction of the TV camera matches a detection result of the head-position detection sensor, and a projector that generates an image light wave from a photographing signal to project it on a screen.

### CITATION LIST

### Patent Literature

Patent Literature 1: Japanese Patent Application Laid-open No. H06-339153 A

### SUMMARY

### Technical Problem

When a two-dimensional image of a work site is displayed on a display apparatus, it is difficult for a worker to perceive the work site with perspective. As a result, the worker cannot perform remote operation smoothly, which can reduce the working efficiency of a work machine. By transmitting a detection signal of the head-position detection sensor from a remote place to the actuator at the work site, operating the actuator so as to move the camera in conjunction with the head of the worker, and transmitting the image photographed by the camera from the work site to the display apparatus at the remote place, the viewpoint of the image displayed on the display apparatus moves in conjunction with the head of the worker. Thus, by presenting motion parallax in conjunction with viewpoint movement, it is possible for the worker to perceive perspective with motion stereo vision and to perform remote operation smoothly.

However, due to the communication delay of the detection signal transmitted from the remote place to the work site or the communication delay of the image transmitted from the work site to the remote place, the movement of the viewpoint of the image to be displayed on the display apparatus can be delayed with respect to the movement of the head of the worker. As a result, it becomes difficult to present motion parallax correctly corresponding to the viewpoint, and it is difficult for the worker to perceive perspective with motion stereo vision.

A purpose of an aspect of the present invention is to provide a display system, a display method, and a remote operation system capable of making a worker who performs remote operation of a work machine effectively perceive a work site with perspective.

### Solution to Problem

According to a first aspect of the present invention, a display system comprises: an image-data acquisition unit configured to acquire image data including three-dimensional data of an object at a work site; a viewpoint-position-data acquisition unit configured to acquire viewpoint position data of a worker; and a display control unit configured to display a free-viewpoint image of the object based on the image data and the viewpoint position data.

According to a second aspect of the present invention, a display method comprises: acquiring image data including three-dimensional data of an object; acquiring viewpoint position data of a worker; and displaying a free-viewpoint image of the object based on the image data and the viewpoint position data.

According to a three aspect of the present invention, a remote operation system comprises: an imaging apparatus mounted on a work machine and configured to acquire image data including three-dimensional data of an object at a work site; a display apparatus provided at a place remote from the work site; a head position sensor provided at the remote place and configured to detect a position and posture of a head of a worker; and a control apparatus provided at the remote place and configured to communicate with the work machine, wherein the control apparatus comprises: an image-data acquisition unit configured to acquire the image data photographed by the imaging apparatus; a viewpoint-position-data acquisition unit configured to acquire viewpoint position data of the worker based on measurement data of the head position sensor; and a display control unit configured to display, based on the image data and the viewpoint position data, a free-viewpoint image of the object on the display apparatus.

### Advantageous Effects of Invention

According to an aspect of the present invention, there is provided a display system and a display method capable of making a worker who performs remote operation of a work machine effectively perceive a work site with perspective.

### BRIEF DESCRIPTION OF DRAWINGS

FIG. 1 is a diagram schematically illustrating an example of a remote operation system of a work machine according to the present embodiment.

FIG. 2 is a diagram schematically illustrating an example of the work machine according to the present embodiment.

FIG. 3 is a diagram schematically illustrating an example of a remote operation facility according to the present embodiment.

FIG. 4 is a functional block diagram illustrating an example of a display system according to the present embodiment.

FIG. 5 is a schematic diagram for explaining motion parallax generated by a free-viewpoint image according to the present embodiment.

FIG. 6 is a flowchart illustrating an example of a display method for the display system according to the present embodiment.

FIG. 7 is a flowchart illustrating an example of the display method for the display system according to the present embodiment.

FIG. 8 is a schematic diagram for explaining coordinate systems set in the work machine according to the present embodiment.

FIG. 9 is a schematic diagram for explaining coordinate systems set in the remote operation facility according to the present embodiment.

FIG. 10 is a schematic diagram for explaining a reference coordinate system according to the present embodiment.

FIG. 11 is a diagram schematically illustrating image data acquired by a camera according to the present embodiment.

FIG. 12 is a diagram schematically illustrating three-dimensional data acquired by a distance sensor according to the present embodiment.

FIG. 13 is a schematic diagram for explaining three-dimensional data according to the present embodiment.

FIG. 14 is a diagram schematically illustrating the remote operation facility according to the present embodiment.

FIG. 15 is a diagram schematically illustrating the relationship between a head marker of a cap and the viewpoint position of a worker according to the present embodiment.

FIG. 16 is a schematic diagram for explaining a coordinate system defined in a display apparatus according to the present embodiment.

FIG. 17 is a diagram schematically illustrating that the worker is performing remote operation according to the present embodiment.

### DESCRIPTION OF EMBODIMENT

Hereinafter, an embodiment of the present invention is described with reference to the drawings, but the present invention is not limited thereto. The constituent elements of the embodiment described below can be appropriately combined. In addition, some constituent elements cannot be used.

[Remote Operation System]

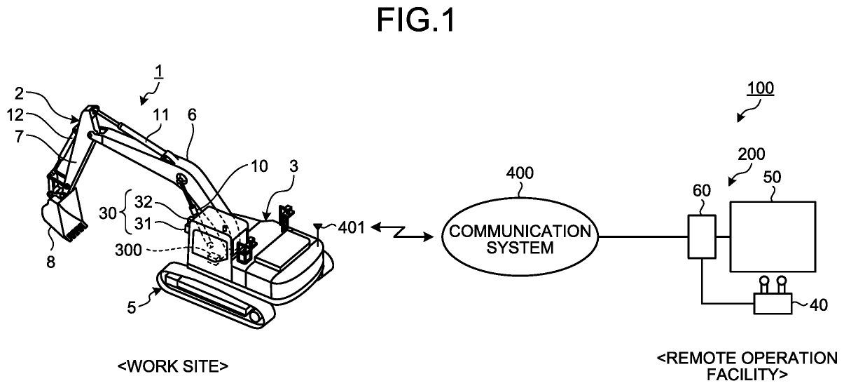

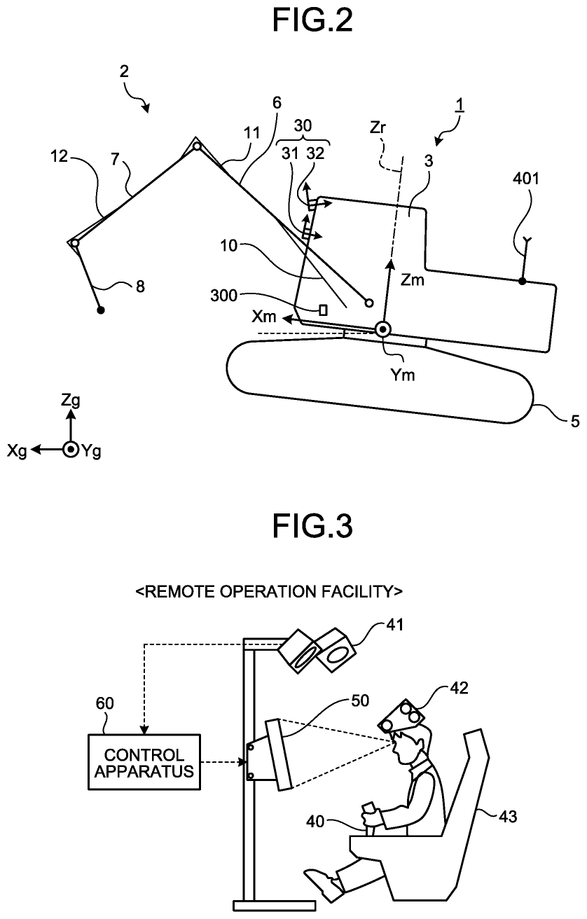

FIG. 1 is a diagram schematically illustrating an example of a remote operation system 100 for a work machine 1 according to the present embodiment. FIG. 2 is a diagram schematically illustrating an example of the work machine 1 according to the present embodiment. In the present embodiment, the work machine 1 is an excavator. In the following description, the work machine 1 is appropriately referred to as an excavator 1.

The excavator 1 includes working equipment 2, a swing body 3, and a traveling body 5 that supports the swing body 3 so as to be swingable. The traveling body 5 has a crawler. The excavator 1 travels by rotating the crawler. The working equipment 2 is coupled to the swing body 3.

The working equipment 2 includes a boom 6 coupled to the swing body 3, an arm 7 coupled to the boom 6, a bucket 8 coupled to the arm 7, a boom cylinder 10 that drives the boom 6, an arm cylinder 11 that drives the arm 7, and a bucket cylinder 12 that drives the bucket 8. The boom cylinder 10, the arm cylinder 11, and the bucket cylinder 12 are hydraulic cylinders driven by hydraulic pressure.

The excavator 1 is at a work site and works at the work site. The remote operation system 100 includes a remote operation apparatus 40 provided in a remote operation facility at a place remote from the work site. The excavator 1 is remotely operated by the remote operation apparatus 40.

The remote operation system 100 includes a display system 200 provided in the remote operation facility that displays an image related to the work site. The display system 200 includes a display apparatus 50 and a control apparatus 60 that are provided in the remote operation facility. Each of the remote operation apparatus 40, the display apparatus 50, and the control apparatus 60 is provided separately from the excavator 1.

The display system 200 includes an imaging apparatus 30 provided at a work site and photographing an object at the work site. In the present embodiment, the imaging apparatus 30 is mounted on the excavator 1. The imaging apparatus 30 includes a camera 31 and a distance sensor 32 capable of measuring the distance to an object at the work site. The camera 31 and the distance sensor 32 are fixed to the swing body 3. The imaging apparatus 30 photographs an object in front of the swing body 3.

In the present embodiment, the object to be photographed by the imaging apparatus 30 includes a construction object to be constructed at the work site. The construction object includes an excavation object to be excavated by the working equipment 2 of the excavator 1. Note that, the construction object may be a construction object to be constructed by a work machine different from the excavator 1 or a construction object to be constructed by a worker. In addition, the construction object is a concept including a construction object before construction, a construction object under construction, and a construction object after construction.

Furthermore, in the present embodiment, the object to be photographed by the imaging apparatus 30 includes at least a part of the excavator 1. The object to be photographed by the imaging apparatus 30 includes, for example, at least one of the working equipment 2, the swing body 3, and the traveling body 5. The working equipment 2 as the object may be the working equipment 2 that is performing excavating operation or the working equipment 2 that is not performing excavating operation. The swing body 3 as the object may be the swing body 3 that is swinging or the swing body 3 that is not swinging. The traveling body 5 as the object may be the traveling body 5 that is traveling or the traveling body 5 that is not traveling. Furthermore, in the present embodiment, the object to be photographed by the imaging apparatus 30 may be a work machine disposed near the excavator 1 to be remotely operated. The object to be photographed by the imaging apparatus 30 may be an excavator different from the excavator 1 to be remotely operated or a dump truck.

The camera 31 includes an optical system and an image sensor that receives light having passed through the optical system. The image sensor includes a Couple Charged Device (CCD) image sensor or a Complementary Metal Oxide Semiconductor (CMOS) image sensor. The distance sensor 32 includes a laser range finder. The laser range finder is an optical instrument that emits a laser beam to an object and measures the distance to the object based on the reflected light of the laser beam reflected by the object.

The camera 31 acquires image data of an object at the work site. The distance sensor 32 emits a laser beam to the visual field area of the optical system of the camera 31 and acquires distance data to the object in the visual field area. The distance sensor 32 acquires, for example, distance data to the object for each of a plurality of pixels of the image sensor. By acquiring the distance data to each of a plurality of portions of the object, three-dimensional data of the object is acquired. By acquiring the distance data to each of the portions of the object in the visual field area of the camera 31, it is possible for the imaging apparatus 30 to acquire the image data including the three-dimensional data of the object at the work site.

The excavator 1 includes a control apparatus 300. The control apparatus 300 and the control apparatus 60 communicate with each other via a communication system 400. The communication system 400 includes a wireless communication device 401 mounted on the excavator 1. The communication system 400 includes at least one of the Internet, a Local Area Network (LAN), a mobile phone communication network, and a satellite communication network.

The remote operation apparatus 40 includes an operating lever that remotely operates the working equipment 2 and the swing body 3 of the excavator 1, and a traveling lever that remotely operates the traveling body 5. The worker operates the remote operation apparatus 40 at the remote operation facility. An operation signal generated by operating the remote operation apparatus 40 is transmitted to the control apparatus 300 via the communication system 400. The control apparatus 300 outputs, based on the operation signal, a control signal for controlling the working equipment 2, the swing body 3, and the traveling body 5. The excavator 1 is thereby remotely operated.

As illustrated in FIG. 2, a three-dimensional global coordinate system (Xg, Yg, Zg) and a three-dimensional vehicle coordinate system (Xm, Ym, Zm) are defined in the present embodiment.

[Remote Operation Facility]

FIG. 3 is a diagram schematically illustrating an example of a remote operation facility according to the present embodiment. As illustrated in FIG. 3, a head position sensor 41 that detects the position and posture of the head of a worker, a cap 42 mounted on the head of the worker, a cockpit 43 in which the worker is seated, a remote operation apparatus 40, a display apparatus 50, and a control apparatus 60 are provided in the remote operation facility.

The head position sensor 41 measures position and posture data of the head of the worker. In the present embodiment, the cap 42 is mounted on the head of the worker. The cap 42 is provided with a head marker. The head position sensor 41 optically measures the head marker of the cap 42 to measure the position and posture data of the head of the worker.

The worker is seated in the cockpit 43 so as to face a display screen of the display apparatus 50. The worker operates the remote operation apparatus 40 while viewing the display screen of the display apparatus 50. The head position sensor 41 measures the position and posture data of the head of the worker seated in the cockpit.

The display apparatus 50 includes a flat panel display, such as a liquid crystal display (LCD) or an organic electroluminescence display (OELD).

The control apparatus 60 includes a computer system. The control apparatus 60 includes an arithmetic processing unit including a processor, such as a central processing unit (CPU), a storage including a volatile memory, such as a random access memory (RAM), and a non-volatile memory, such as a read only memory (ROM), and an input/output interface.

[Display System]

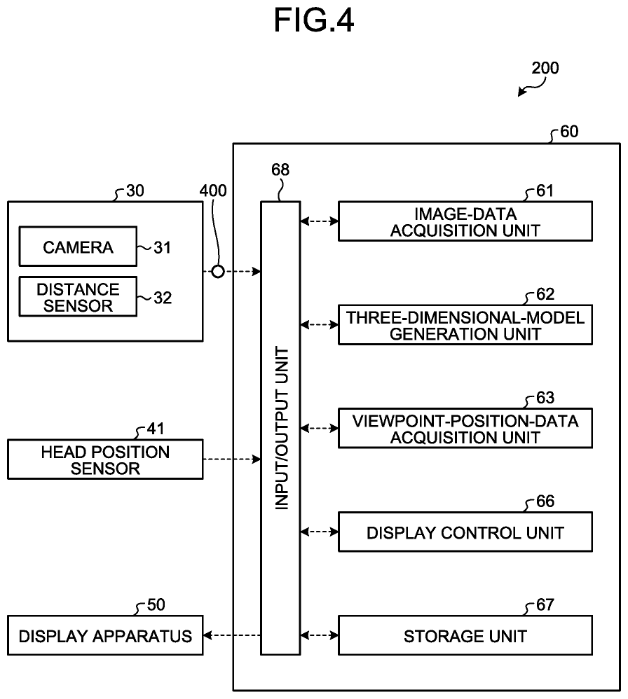

FIG. 4 is a functional block diagram illustrating an example of the display system 200 according to the present embodiment. As illustrated in FIG. 4, the display system 200 includes a head position sensor 41, a display apparatus 50, and a control apparatus 60, which are provided in the remote operation facility.

The imaging apparatus 30 includes a camera 31 and a distance sensor 32. The imaging apparatus 30 acquires image data including three-dimensional data of the object at the work site. The image data acquired by the imaging apparatus 30 is transmitted to the control apparatus 60 via the communication system 400. Measurement data of the head position sensor 41 is output to the control apparatus 60.

The control apparatus 60 includes an image-data acquisition unit 61, a three-dimensional-model generation unit 62, a viewpoint-position-data acquisition unit 63, a display control unit 66, a storage unit 67, and an input/output unit 68.

The image-data acquisition unit 61 acquires the image data including the three-dimensional data of the object at the work site from the imaging apparatus 30 via the communication system 400. The image data acquired by the image-data acquisition unit 61 is temporarily stored in the storage unit 67.

The three-dimensional-model generation unit 62 generates a three-dimensional model of the object based on the image data acquired by the image-data acquisition unit 61. The three-dimensional model generated by the three-dimensional-model generation unit 62 is temporarily stored in the storage unit 67.

The viewpoint-position-data acquisition unit 63 acquires viewpoint position data of the worker based on the measurement data of the head position sensor 41. The head position sensor 41 is capable of successively acquiring the position and posture data of the head of the worker. The viewpoint position data changes successively. The viewpoint position can be considered to be dependently determined from the position and posture of the head. The relative position between the head and the viewpoint is known data and is stored in the storage unit 67. The viewpoint-position-data acquisition unit 63 can acquire the viewpoint position data of the worker based on the measurement data of the head position sensor 41 and the known data stored in the storage unit 67.

The storage unit 67 temporarily stores the image data acquired by the image-data acquisition unit 61. The image-data acquisition unit 61 acquires the image data in a data update cycle that is a predetermined cycle. The acquired image data is sequentially stored in the storage unit 67 in the data update cycle. In the present embodiment, the image data stored in the storage unit 67 is sequentially updated in the data update cycle. That is, the storage unit 67 temporarily stores the latest image data acquired by the image-data acquisition unit 61 and deletes old image data.

In addition, the storage unit 67 temporarily stores the three-dimensional model generated by the three-dimensional-model generation unit 62. The three-dimensional-model generation unit 62 generates the three-dimensional model in a data update cycle that is a predetermined cycle. The generated three-dimensional model is sequentially stored in the storage unit 67 in the data update cycle. In the present embodiment, the three-dimensional model stored in the storage unit 67 is sequentially updated in the data update cycle. That is, the storage unit 67 temporarily stores the latest three-dimensional model generated by the three-dimensional-model generation unit 62 and deletes an old three-dimensional model.

In addition, the storage unit 67 stores position data of the imaging apparatus 30 in the vehicle coordinate system. The position data of the imaging apparatus 30 in the vehicle coordinate system is known data derived from design data or specification data of the excavator 1 and the imaging apparatus 30, and is stored in the storage unit 67.

The display control unit 66 performs, based on the image data including the three-dimensional data of the object, free-viewpoint image generation to convert the object into an image viewed from an arbitrary virtual viewpoint. The image generated by the free-viewpoint image generation is referred to as a free-viewpoint image.

In the present embodiment, the display control unit 66 performs, based on at least one of the latest image data and the latest three-dimensional model temporarily stored in the storage unit 67, and on the viewpoint position data acquired by the viewpoint-position-data acquisition unit 63, the free-viewpoint image generation and displays the free-viewpoint image on the display apparatus 50.

In the present embodiment, the display control unit 66 presents motion parallax to the worker by continuously displaying, on the display apparatus 50, the image of the object viewed from the virtual viewpoint corresponding to the viewpoint position of the worker in conjunction with the movement of the viewpoint position of the worker, that is, the free-viewpoint image. With the motion stereo vision based on the presented motion parallax, it is possible for the worker to perceive and recognize the displayed object with perspective.

The viewpoint position data changes successively. The display control unit 66 successively generates the free-viewpoint image in response to the change of the viewpoint position data and displays the free-viewpoint image on a display apparatus 60.

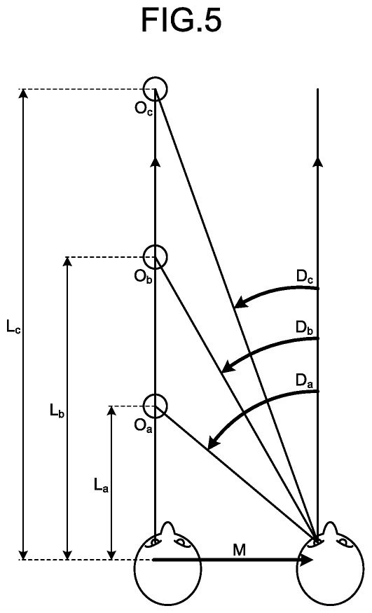

FIG. 5 is a schematic diagram for explaining motion parallax generated by a free-viewpoint image according to the present embodiment. In the present embodiment, the display control unit 66 continuously displays, on the display apparatus 50, the free-viewpoint image of the object viewed from a virtual viewpoint corresponding to the viewpoint position of the worker in conjunction with the movement of the viewpoint (pupil) of the worker. The display control unit 66 displays the free-viewpoint image on the display apparatus 50 so that, in the continuously displayed free-viewpoint image, the apparent movement amount of a portion close to the worker is large and the apparent movement amount of a portion far from the worker is small.

That is, as illustrated in FIG. 5, when the viewpoint of the worker moves by the distance M, the display control unit 66 displays the free-viewpoint image by moving the visual position of the portion Oa positioned at the distance La close to the worker by the angle Da, moving the visual position of the portion Ob positioned at the distance Lb far from the worker by the angle Db smaller than the angle Da, and moving the visual position of the portion Oc positioned at the distance Lc farther from the worker by the angle Dc smaller than the angle Db. With the differences between the angle Da, the angle Db, and the angle Dc by which the visual positions of the portion Oa, the portion Ob, and the portion Oc have moved respectively, it is possible for the worker to perceive the portion Oa at the position away from the worker by the distance La, the portion Ob at the position away by the distance Lb, and the portion Oc at the position away by the distance Lc. With the change of the free-viewpoint image in conjunction with the movement of the viewpoint of the worker, motion parallax is generated, and it is possible for the worker to perceive perspective with motion stereo vision.

[Display Method]

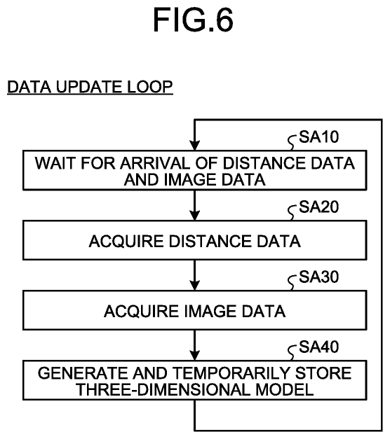

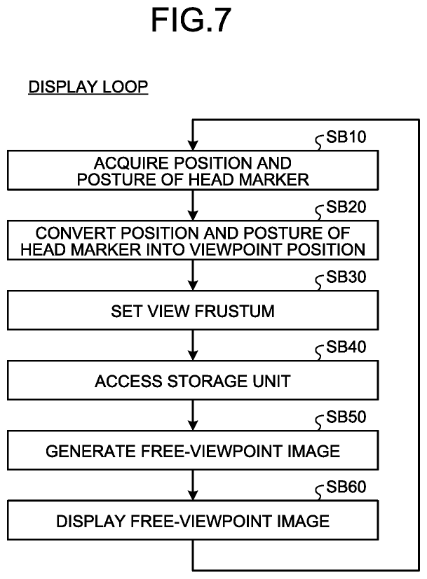

FIGS. 6 and 7 are flowcharts illustrating an example of a display method for the display system 200 according to the present embodiment. The display method according to the present embodiment includes a data update loop SA as illustrated in FIG. 6 and a display loop SB as illustrated in FIG. 7.

The data update loop SA includes a step SA10 of waiting for arrival (reception) of the distance data and image data from the imaging apparatus 30 at the work site, a step SA20 of acquiring the distance data of the object at the work site from the distance sensor 32 of the imaging apparatus 30, a step SA30 of acquiring the image data of the object at the work site from the camera 31 of the imaging apparatus 30, and a step SA40 of generating a three-dimensional model of the object based on the image data including the distance data and of temporarily storing the three-dimensional model in the storage unit 67.

The display loop SB includes a step SB10 of acquiring the position and posture of the head marker, a step SB20 of converting the position and posture of the head marker into a viewpoint position to acquire viewpoint position data of the worker, a step SB30 of setting a view frustum, a step SB40 of accessing the three-dimensional model temporarily stored in the storage unit 67, a step SB50 of generating a free-viewpoint image of the object based on the viewpoint position data of the worker and the three-dimensional model acquired from the storage unit 67, and a step SB60 of displaying the free-viewpoint image generated in step SB50 on the display apparatus 50.

The image data photographed by the imaging apparatus 30 is transmitted to the image-data acquisition unit 61 in the remote operation facility in a predetermined sampling cycle. The data update loop SA is performed in the data update cycle. Since the data update loop SA includes the step SA10 of waiting for reception of the distance data and image data from the imaging apparatus 30, the data update cycle depends on the predetermined sampling cycle. In addition, since reception of the data can be delayed, stagnated, performed in an unfixed cycle, or dropped depending on the state of the communication system 400, the data update cycle can be unstable.

The display control unit 66 displays, based on the three-dimensional model stored in the storage unit 67, the free-viewpoint image on the display apparatus 50 in a display cycle shorter than the data update cycle. That is, the display loop SB is performed in the display cycle shorter than the data update cycle in the present embodiment.

In the present embodiment, the data update loop SA and the display loop SB are performed in parallel at mutually independent timings.

(Coordinate System)

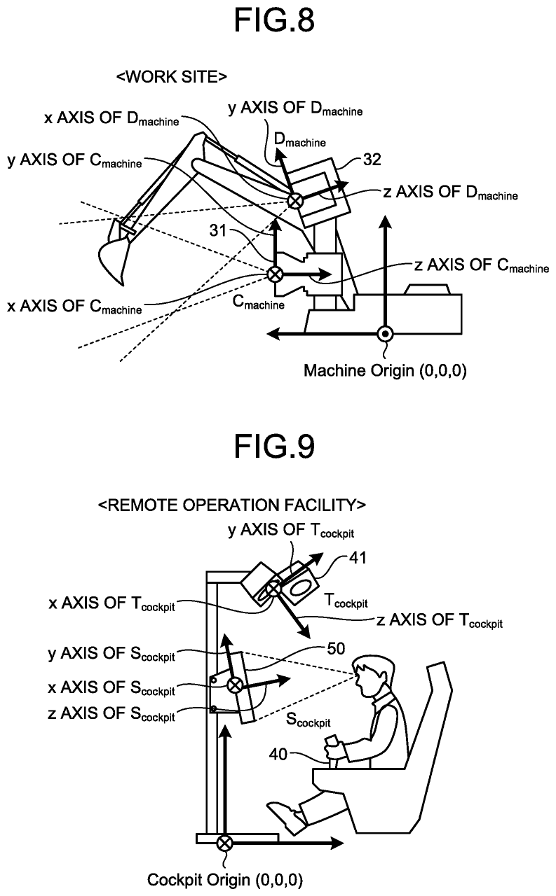

Before describing details of the data update loop SA and the display loop SB, coordinate systems set in the excavator 1 and the remote operation facility are described. FIG. 8 is a schematic diagram for explaining a coordinate system set in the excavator 1 according to the present embodiment. FIG. 9 is a schematic diagram for explaining a coordinate system set in the remote operation facility according to the present embodiment.

As illustrated in FIG. 8, a vehicle coordinate system is set in the swing body 3. In addition, a camera coordinate system is set in the camera 31, and a distance-sensor coordinate system is set in the distance sensor 32. The position and posture of the camera 31 are represented by Cmachine, which is a matrix defined in the vehicle coordinate system of the swing body 3. The position and posture of the distance sensor 32 are represented by Dmachine, which is a matrix defined in the vehicle coordinate system of the swing body 3. Each of the matrices Cmachine and Dmachine is a 4×4 homogeneous transformation matrix representing a position and posture.

As illustrated in FIG. 9, an operation-facility coordinate system is set in the remote operation facility. In addition, a display-apparatus coordinate system is set in the display apparatus 50, and a head-position-sensor coordinate system is set in the head position sensor 41. The position and posture of the display apparatus 50 are represented by Scockpit, which is a matrix defined in the operation-facility coordinate system of the remote operation facility. The position and posture of the head position sensor 41 are represented by Tcockpit, which is a matrix defined in the operation-facility coordinate system of the remote operation facility. Each of the matrices Scockpit and Tcockpit is a 4×4 homogeneous transformation matrix representing a position and posture.

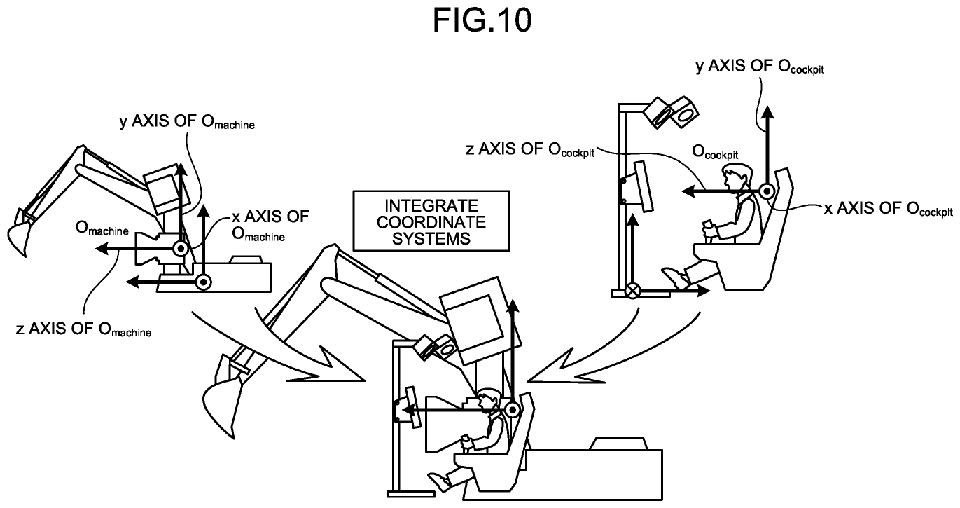

FIG. 10 is a schematic diagram for explaining a reference coordinate system according to the present embodiment. As illustrated in FIG. 10, the vehicle coordinate system defined in the swing body 3 and the operation-facility coordinate system defined in the remote operation facility are integrated in the present embodiment. That is, a new matrix Omachine and a new matrix Ocockpit are introduced respectively to the excavator 1 and the remote operation facility. The vehicle coordinate system defined in the swing body 3 and the operation-facility coordinate system defined in the remote operation facility are integrated so that the reference positions and postures in the two coordinate systems coincide. By integrating the vehicle coordinate system and the operation-facility coordinate system, it is possible to determine, for example, which position of the excavator 1 corresponds to the position of a part of the remote operation facility.

The positions and postures of the constituent elements of the excavator 1 and the remote operation facility in the reference coordinate system are expressed by the following equations (1) to (4).

C=O_{machine}⁻¹×C_{machine} (1)

D=O_{machine}⁻¹×D_{machine} (2)

T=O_{cockpit}⁻¹×T_{cockpit} (3)

S=O_{cockpit}⁻¹×S_{cockpit} (4)

(Data Update Loop)

Next, the data update loop SA is described. The camera 31 and the distance sensor 32 are fixed to the swing body 3 at different positions and postures from each other. The three-dimensional-model generation unit 62 combines the image data acquired by the camera 31 and the distance data acquired by the distance sensor 32 to generate a colored three-dimensional model. The three-dimensional-model generation unit 62 generates the three-dimensional model by combining the position, angle, and size of the image data with the position, angle, and size of the distance data so as to coincide.

The image-data acquisition unit 61 waits for arrival (reception) of the image data from the camera 31 and the distance data from the distance sensor 32 (step SA10). As described above, in the present embodiment, the distance data and the image data acquired by the imaging apparatus 30 are transmitted to the image-data acquisition unit 61 in a predetermined sampling cycle.

The image-data acquisition unit 61 acquires the distance data from the distance sensor 32 (step SA20). The image-data acquisition unit 61 further acquires the image data from the camera 31 (step SA30).

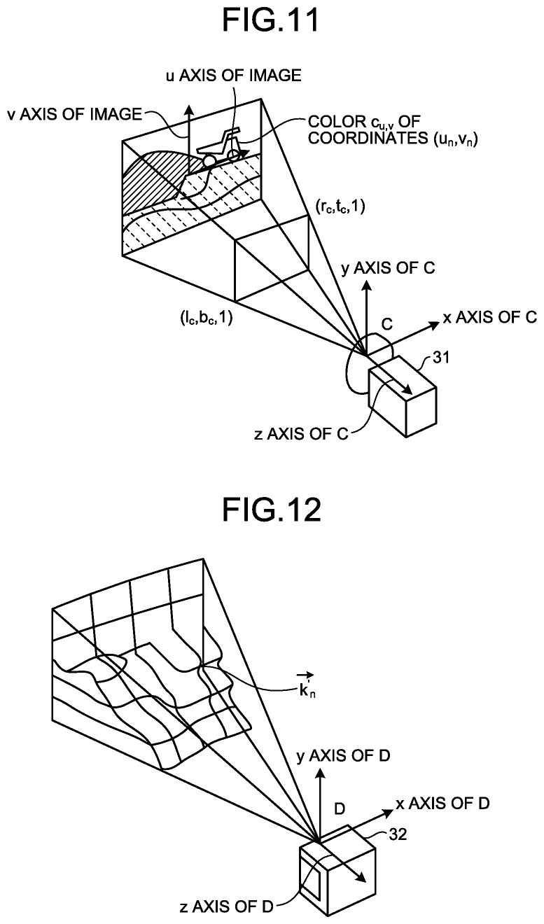

FIG. 11 is a diagram schematically illustrating image data acquired by the camera 31 according to the present embodiment. FIG. 12 is a diagram schematically illustrating distance data (three-dimensional data) acquired by the distance sensor 32 according to the present embodiment.

As illustrated in FIG. 11, the image data acquired by the camera 31 includes a set of colored pixel data arranged on two-dimensional UV coordinates.

As illustrated in FIG. 12, the distance data acquired by the distance sensor 32 includes a set of three-dimensional data of a plurality of portions of the object.

The three-dimensional data acquired by the distance sensor 32 is represented by the local coordinate system of the distance sensor 32. The three-dimensional-model generation unit 62 converts the three-dimensional data into the reference coordinate system based on the matrix D of the distance sensor.

The three-dimensional-model generation unit 62 generates the colored three-dimensional model by allocating the pixel data of the camera 31 so as to project the pixel data of the camera 31 onto the three-dimensional data acquired by the distance sensor 32 based on the position and posture of the camera 31, internal parameters (the angle of view and the optical axis center), and the position and posture of the distance sensor 32.

FIG. 13 is a schematic diagram for explaining a three-dimensional model according to the present embodiment. FIG. 13 is a diagram schematically illustrating a three-dimensional model obtained by projecting the pixel data of the camera 31 onto the three-dimensional data acquired by the distance sensor 32 and coloring the three-dimensional data. In this manner, the three-dimensional-model generation unit 62 generates the three-dimensional model representing the color and shape of the object (step SA40).

The three-dimensional model generated by the three-dimensional-model generation unit 62 is temporarily stored in the storage unit 67. As described above, the three-dimensional-model generation unit 62 generates the three-dimensional model in the data update cycle. The storage unit 67 sequentially stores the generated three-dimensional model in the data update cycle. The three-dimensional model stored in the storage unit 67 is sequentially updated in the data update cycle. The storage unit 67 temporarily stores the latest three-dimensional model and deletes an old three-dimensional model.

(Display Loop)

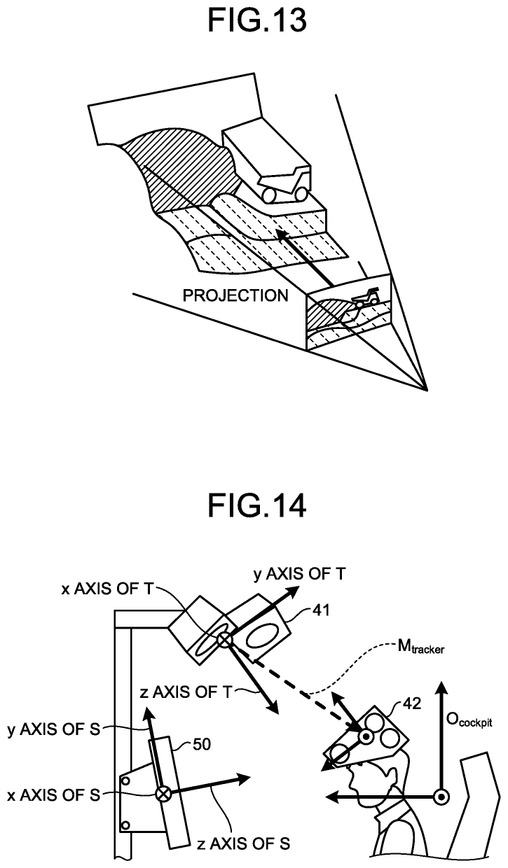

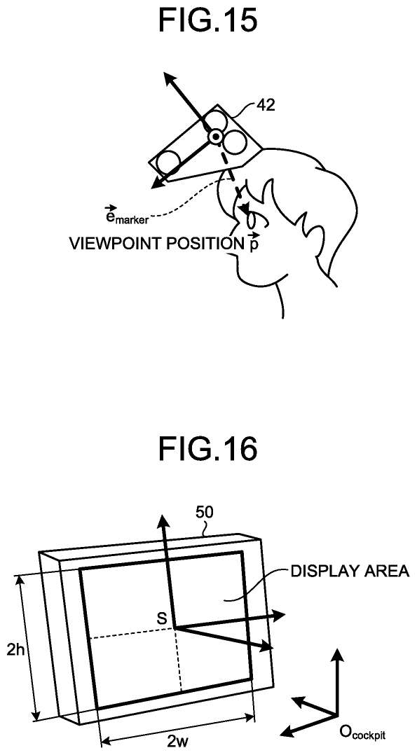

Next, the display loop SB is described. FIG. 14 is a diagram schematically illustrating the remote operation facility according to the present embodiment. FIG. 15 is a diagram schematically illustrating the relationship between the head marker of the cap 42 and the viewpoint position of the worker according to the present embodiment. The viewpoint position means the pupil position of the right eye, the pupil position of the left eye, or the intermediate position (centroid) between the pupil position of the right eye and the pupil position of the left eye. When binocular stereovision is used in combination, the viewpoint position means the pupil positions of both eyes.

The head position sensor 41 measures the position and posture of the head marker provided on the cap 42 mounted on the worker. The viewpoint-position-data acquisition unit 63 acquires the position and posture of the head marker measured by the head position sensor 41 (step SB10).

The viewpoint-position-data acquisition unit 63 converts the position and posture of the head marker into the coordinates of the viewpoint of the worker (step SB20). The position of the head marker Mtracker measured by the head position sensor 41 is indicated by the local coordinate system of the head position sensor 41 and represents the position and posture viewed from the head position sensor 41. Thus, the viewpoint-position-data acquisition unit 63 converts the position and posture of the head marker into the viewpoint position of the worker in the reference coordinate system.

The viewpoint-position-data acquisition unit 63 introduces a column vector expressed by equation (5) in order to convert the position and posture of the head marker into the viewpoint position of the worker.

$${\vec{e}}_{marker} = ( \begin{matrix}{x}_{e} \\ {y}_{e} \\ {z}_{e}\end{matrix} ) \qquad ( 5 )$$

The viewpoint position of the worker in the reference coordinate system is obtained based on equation (6).

$$( \begin{matrix}\vec{p} \\ 1\end{matrix} ) = T \times {M}_{tracker} \times ( \begin{matrix}{\vec{e}}_{marker} \\ 1\end{matrix} ) \qquad ( 6 )$$

In this manner, it is possible for the viewpoint-position-data acquisition unit 63 to acquire the viewpoint position of the worker in the reference coordinate system, that is, the position data of the pupil.

(Measurement of Position, Posture, and Size of Display Apparatus)

Next, measurement of the position, posture, and size of the display screen of the display apparatus 50 is described. For the implementation of motion stereo vision, it is necessary to present an undistorted three-dimensional space, as if the display screen of the display apparatus 50 is a transparent window. For this purpose, it is necessary to exactly grasp spatial arrangement information of the display apparatus 50.

FIG. 16 is a schematic diagram for explaining a coordinate system defined in the display apparatus 50 according to the present embodiment. As illustrated in FIG. 16, the spatial arrangement of the display apparatus 50 is expressed by the matrix S, the width of the display area 2w, and the height of the display area 2h. These values are determined in advance by performing calibration for the display apparatus 50.

(Display of Free-Viewpoint Image)

Next, the display control unit 66 performs rendering (drawing) processing to display a free-viewpoint image.

The display control unit 66 performs perspective projection transformation to the three-dimensional model viewed from the viewpoint position to map it onto the display apparatus 50. As the result, a free-viewpoint image (completed image) having a viewpoint different from that of the image data acquired by the camera 31 is obtained. When the matrix S is expressed by equation (7) and the viewpoint represented by equation (8), which has the posture facing the display apparatus 50, is taken into consideration, the matrix A for converting the S coordinate system into the P coordinate system is expressed by equation (9).

$$\begin{matrix}S = ( \begin{matrix} & R & & \vec{t} \\ 0 & 0 & 0 & 1\end{matrix} ) & ( 7 ) \\ P = ( \begin{matrix} & R & & \vec{p} \\ 0 & 0 & 0 & 1\end{matrix} ) & ( 8 ) \\ A = {P}^{- 1} \times S & ( 9 )\end{matrix}$$

The display control unit 66 sets the parameters (lₚ, rₚ, bₚ, tₚ, nₚ) of the view frustum based on P as in equations (10), (11), (12), and (13) (step SB30).

$$\begin{matrix}( \begin{matrix}{l}_{p} \\ 0 \\ - {n}_{p} \\ 1\end{matrix} ) = A ( \begin{matrix}- w \\ 0 \\ 0 \\ 1\end{matrix} ) & ( 10 ) \\ ( \begin{matrix}{r}_{p} \\ 0 \\ - {n}_{p} \\ 1\end{matrix} ) = A ( \begin{matrix}w \\ 0 \\ 0 \\ 1\end{matrix} ) & ( 11 ) \\ ( \begin{matrix}0 \\ {b}_{p} \\ - {n}_{p} \\ 1\end{matrix} ) = A ( \begin{matrix}0 \\ - h \\ 0 \\ 1\end{matrix} ) & ( 12 ) \\ ( \begin{matrix}0 \\ {t}_{p} \\ - {n}_{p} \\ 1\end{matrix} ) = A ( \begin{matrix}0 \\ h \\ 0 \\ 1\end{matrix} ) & ( 13 )\end{matrix}$$

The display control unit 66 accesses the three-dimensional model stored in the storage unit 67 (step SB40). The three-dimensional model stored in the storage unit 67 is sequentially updated in the data update cycle. Thus, the display control unit 66 can acquire the latest three-dimensional model.

If the distant drawing range f is appropriately determined, the projection matrix Fp can be obtained by equation (14).

$${F}_{p} = ( \begin{matrix}\frac{2 {n}_{p}}{{r}_{p} - {l}_{p}} & 0 & \frac{{r}_{p} + {l}_{p}}{{r}_{p} - {l}_{p}} & 0 \\ 0 & \frac{2 {n}_{p}}{{t}_{p} - {b}_{p}} & \frac{{t}_{p} + {b}_{p}}{{t}_{p} - {b}_{p}} & 0 \\ 0 & 0 & - \frac{f + {n}_{p}}{f - {n}_{p}} & - \frac{2 {fn}_{p}}{f + {n}_{p}} \\ 0 & 0 & - 1 & 0\end{matrix} ) \qquad ( 14 )$$

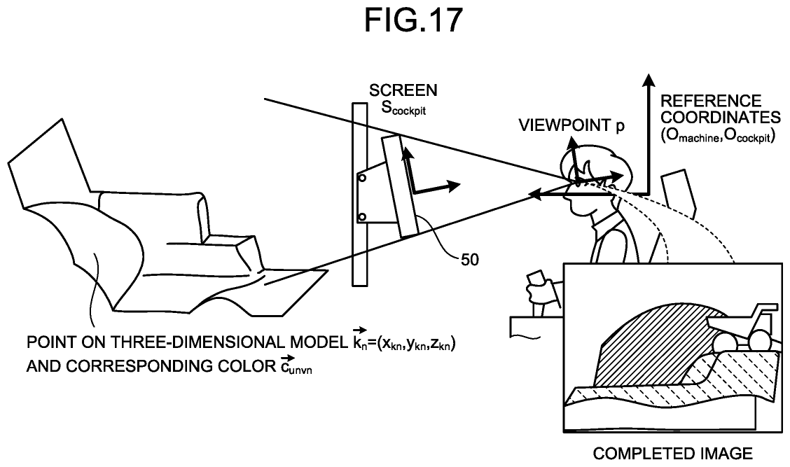

FIG. 17 is a diagram schematically illustrating that the worker is performing remote operation according to the present embodiment. The display control unit 66 generates a free-viewpoint image by performing perspective projection transformation to the three-dimensional model with Fp×P⁻¹ based on equation (14) (step SB50). The display control unit 66 displays the free-viewpoint image generated in step SB50 on the display apparatus 50 (step SB60). In this manner, the free-viewpoint image is generated so that the appearance of the object viewed through the screen changes when the worker moves the viewpoint, and that the appearance of the object has the correct three-dimensional shape.

[Effect]

As described above, according to the present embodiment, image data including three-dimensional data is transmitted from the work site to the remote operation facility. The display control unit 66 displays a free-viewpoint image on the display apparatus 50 in the remote operation facility based on the viewpoint position data of the worker. In the present embodiment, the viewpoint position data of the worker is not transmitted to the work site and is used to generate and display the free-viewpoint image in the remote operation facility. Thus, it is possible for the display control unit 66 to display the free-viewpoint image based on the viewpoint position data of the worker without being affected by the communication delay between the work site and the remote operation facility. This reduces the delay in the display of the free-viewpoint image to be displayed on the display apparatus 50 with respect to the movement of the viewpoint of the worker. Thus, it is possible to reduce the delay in the motion parallax with respect to the movement of the viewpoint of the worker and to make the worker effectively perceive the work site with perspective with motion stereo vision. Accordingly, it is possible for the worker to smoothly perform the remote operation while viewing the free-viewpoint image displayed on the display apparatus 50. It is thereby possible to suppress decrease in the working efficiency of the excavator 1.

In the present embodiment, the data update loop SA for generating a three-dimensional model in a data update cycle based on the image data including the three-dimensional data transmitted from the work site to the remote operation facility and for sequentially storing the three-dimensional model in the storage unit 67 in the data update cycle and a display loop SB for sequentially displaying a free-viewpoint image generated from the three-dimensional model stored in the storage unit 67 in a display cycle shorter than the data update cycle based on the viewpoint position data of the worker are performed in parallel at mutually independent timings. Thus, although transmission of image data from the work site to the remote operation facility is delayed or has not been performed, the display control unit 66 can display the free-viewpoint image on the display apparatus 50 based on the latest three-dimensional model generated most recently. It is thereby possible to continuously present motion parallax correctly corresponding to the movement of the viewpoint.

In addition, since the data update loop SA and the display loop SB are performed in parallel at mutually independent timings, although the data update cycle depending on the frequency at which the remote operation facility receives image data including three-dimensional data from the work site is longer than the display cycle for displaying a free-viewpoint image to be sequentially displayed on the display apparatus 50, the display control unit 66 can display the free-viewpoint image on the display apparatus 50 based on the latest three-dimensional model generated most recently and stored in the storage unit 67. That is, although the remote operation facility receives image data including three-dimensional data from the work site at a low frequency or unstably, the control apparatus 60 can display the free-viewpoint image on the display apparatus 50 with good display quality by performing the display loop SB at a high speed so that the delay until the image corresponding to viewpoint movement is observed is not recognized. It is thereby possible for the worker to operate the remote operation apparatus 40 while viewing the free-viewpoint image displayed in a good display environment.

[Other Embodiments]

In the above embodiment, in the data update loop SA, the three-dimensional model generated by the three-dimensional-model generation unit 62 has been sequentially stored in the storage unit 67 in the data update cycle. In the data update loop SA, the image data acquired by the image-data acquisition unit 61 may be sequentially stored in the storage unit 67 in the data update cycle. In addition, the image data stored in the storage unit 67 may be sequentially updated in the data update cycle. The display control unit 66 can display, based on the latest image data stored in the storage unit 67, the free-viewpoint image on the display apparatus 50 in a display cycle shorter than the data update cycle.

In the above embodiment, in the data update loop SA, the image data or the three-dimensional model stored in the storage unit 67 has been sequentially updated in the data update cycle. That is, the latest image data or the latest three-dimensional model has been temporarily stored in the storage unit 67, and old image data or an old three-dimensional model has been deleted. The old image data or the old three-dimensional model may not be deleted and may be held in the storage unit 67. In this case, based on a plurality of pieces of image data or a plurality of three-dimensional models stored in the storage unit 67 in the data update cycle, and on a swing history of the swing body 3 of the excavator 1 or a travel history of the traveling body 5, the display control unit 66 can display a wide-range and high-definition free-viewpoint image on the display apparatus 50.

In the above embodiment, a plurality of display apparatuses 50 may be provided in parallel. In addition, the display screen of the display apparatus 50 may have a flat surface or a dome-shaped curved surface. Furthermore, the display apparatus 50 may be a head mounted display to be mounted on the head of the worker.

In the above embodiment, the imaging apparatus 30 has been mounted on the excavator 1. The imaging apparatus 30 can be provided at any position as long as it can photograph the object at the work site. For example, the imaging apparatus 30 may be mounted on a work machine different from the excavator 1 to be remotely operated or on a flying object, such as a drone, or may be provided to a structure at the work site.

In the above embodiment, the viewpoint position data of the worker has been acquired by the optical head position sensor 41 measuring the position and posture data of the head of the worker. For example, the position and posture data of the head of the worker may be measured by a magnetic head position sensor, or the position data of the pupil of the worker may be directly measured by a visual line detector.

In the above embodiment, the imaging apparatus 30 has included the camera 31 that acquires two-dimensional image data and the distance sensor 32 that acquires distance data. The imaging apparatus 30 may be a stereo camera. The stereo camera can also acquire image data including three-dimensional data of the object at the work site.

In each embodiment, the work machine 1 has been an excavator. The work machine 1 may be any work machine capable of constructing a construction object, and may be an excavation machine capable of excavating a construction object or a transporting machine capable of transporting earth and sand. The work machine 1 may be, for example, a wheel loader, a bulldozer, or a dump truck.

### REFERENCE SIGNS LIST

1 EXCAVATOR (WORK MACHINE)

2 WORKING EQUIPMENT

3 SWING BODY

5 TRAVELING BODY

6 BOOM

7 ARM

8 BUCKET

10 BOOM CYLINDER

11 ARM CYLINDER

12 BUCKET CYLINDER

30 IMAGING APPARATUS

31 CAMERA

32 DISTANCE SENSOR

40 REMOTE OPERATION APPARATUS

41 HEAD POSITION SENSOR

42 CAP

43 COCKPIT

50 DISPLAY APPARATUS

60 CONTROL APPARATUS

61 IMAGE-DATA ACQUISITION UNIT

62 THREE-DIMENSIONAL-MODEL GENERATION UNIT

63 VIEWPOINT-POSITION-DATA ACQUISITION UNIT

66 DISPLAY CONTROL UNIT

67 STORAGE UNIT

68 INPUT/OUTPUT UNIT

100 REMOTE OPERATION SYSTEM

200 DISPLAY SYSTEM

300 CONTROL APPARATUS

400 COMMUNICATIONS SYSTEM

401 WIRELESS COMMUNICATION DEVICE

1. A display system comprising:
an image-data acquisition unit configured to acquire image data including three-dimensional data of an object at a work site;
a viewpoint-position-data acquisition unit configured to acquire viewpoint position data of a worker; and
a display control unit configured to display a free-viewpoint image of the object based on the image data and the viewpoint position data.

2. The display system according to claim 1, wherein
the image-data acquisition unit, the viewpoint-position-data acquisition unit, and the display control unit are provided at a place remote from the work site,
the image data or a three-dimensional model of the object to be generated based on the image data is sequentially stored in a storage unit provided at the remote place in a data update cycle, and
the display control unit displays, based on the image data or the three-dimensional model stored in the storage unit, the free-viewpoint image in a display cycle shorter than the data update cycle.

3. The display system according to claim 2, wherein
the image data or the three-dimensional model stored in the storage unit is sequentially updated in the data update cycle, and
the display control unit displays the free-viewpoint image based on the latest image data or the latest three-dimensional model stored in the storage unit.

4. The display system according to claim 1, wherein
the viewpoint position data changes successively, and
the display control unit successively generates and displays the free-viewpoint image in response to the change of the viewpoint position data.

5. The display system according to claim 1, wherein
the image data is acquired by an imaging apparatus and
the imaging apparatus comprises a camera and a distance sensor configured to measure a distance to the object.

6. The display system according to claim 1, wherein
the image data is acquired by an imaging apparatus and
the imaging apparatus is mounted on a work machine that works at the work site.

7. A display method comprising:
acquiring image data including three-dimensional data of an object;
acquiring viewpoint position data of a worker; and
displaying a free-viewpoint image of the object based on the image data and the viewpoint position data.

8. A remote operation system comprising:
an imaging apparatus mounted on a work machine and configured to acquire image data including three-dimensional data of an object at a work site;
a display apparatus provided at a place remote from the work site;
a head position sensor provided at the remote place and configured to detect a position and posture of a head of a worker; and
a control apparatus provided at the remote place and configured to communicate with the work machine, wherein
the control apparatus comprises:
an image-data acquisition unit configured to acquire the image data photographed by the imaging apparatus;
a viewpoint-position-data acquisition unit configured to acquire viewpoint position data of the worker based on measurement data of the head position sensor; and
a display control unit configured to display, based on the image data and the viewpoint position data, a free-viewpoint image of the object on the display apparatus.
